(19) United States
(12) Patent Application Publication
(10) Pub. No.: US 2026/0339858 A1
(43) Pub. Date: Oct. 29, 2026

(54) SYSTEM AND METHOD FOR MANAGING BUS BAR OPERATION LIMITS BASED ON TOPOLOGY OF A SYSTEM

(71) Applicant: Dell Products L.P., Round Rock, TX (US)

(72) Inventors: MICHAEL J. STUMPF, Cedar Park, TX (US); SANDOR TIBOR FARKAS, Round Rock, TX (US)

(21) Appl. No.: 19/193,051

(22) Filed: Apr. 29, 2025

(51) Int. Cl. G06F 13/20

(52) U.S. Cl. CPC G06F 13/20; G06F 2213/40

(57) ABSTRACT

Methods, systems, and devices are provided for managing operation of a rack that may house data processing systems. To manage operation of the rack, current flow measurements of current along a length of a bus bar of the rack may be obtained and used to identify relative placements of data processing systems that draw power from the bus bar and power shelves that supply the power to the bus bar. The relative placements may be used to make a determination regarding operation of the rack has exceeded system limits. Based on the determination indicating the rack has exceeded the system limits, a remediation process may be performed to mitigate impacts of the operation of the rack beyond the operating limits. By doing so, the likelihood of negative impacts of overloading the rack system may be reduced and the provisioning of desired computer implemented services may be facilitated.

### FIELD

Embodiments disclosed herein relate generally to management of data processing systems. More particularly, embodiments disclosed herein relate to systems and methods for mitigating damage to data processing systems.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram illustrating a portion of a busbar in accordance with an embodiment.

FIGS. 2B-2C show diagrams illustrating a bar clip in accordance with an embodiment.

FIGS. 2D-2E show data flow diagrams of a method for managing operation of a rack in accordance with an embodiment.

FIG. 2F shows a diagram illustrating a system in accordance with an embodiment.

FIGS. 2G-2H show data flow diagrams of a method for managing operation of a rack in accordance with an embodiment.

FIG. 3A-3B show flow diagrams illustrating a method for managing operation of a rack in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide, at least in part, computer implemented services. The computer-implemented services may be provided to any type and/or number of other devices and/or users of the data processing systems. Furthermore, the provided computer implemented services may be of any quantity and/or type of such services.

To provide the computer implemented services, the data processing systems may include hardware components. For example, operation of these hardware components may facilitate various functionalities of a data processing system of the data processing systems, thereby causing the data processing system to provide the computer implemented services.

To enable such operation of the hardware components, the hardware components may consume power required for such operation. This power may be provided by at least one power supply unit, such as any number of power supply units positioned with a power shelf to provide power to a power bus (e.g., busbar 110), the power bus then redistributing that power to any number of data processing systems housed in chassis positioned in a rack of a rack system. For example, the power supply units may receive alternating current “AC” and may convert the AC to direct current “DC” in order to provide to a power bus to supply power to data processing systems housed in chassis positioned in the rack.

However, the direct current supplied to the data processing system via the power bus may exceed the operation limits of the power bus. For example, the power bus may be capable of supplying a specific amount of power (e.g., direct current) to data processing systems in the rack. If a higher draw of direct current than the power bus is created to support, the power bus may fail, as such the future distribution of power may be negatively impacted.

For example, the power supply unit may be positioned at the bottom of the rack and the data processing systems positioned above the power supply unit within the rack. In this scenario, the distribution of power (e.g., current flow distribution) to the data processing systems may exceed the operation limits of the busbar (e.g., the bus bar is operating beyond operations limits) and as such, the likelihood of damage to the system may be increased.

For example, should the busbar be deprecated and/or otherwise damaged due to current flow distribution exceeding the operation limits of the busbar, the distribution of power may become inefficient, unpredictable, or irreparable without significant and/or time-consuming replacements to the rack system. For example, if the current flowing through the busbar exceeds operation limits of the busbar, heat may be generated and excessive heat may melt supporting plastic components, thus leading to electrical fires. Consequently, such services as the computer implemented services may thereby be delayed and/or prevented entirely.

To decrease a likelihood of these negative impacts, a method including obtaining current flow measurements of current along a length of a bus bar of the rack to determine the relative positioning of data processing systems and/or power shelves within the rack unit. The current flow measurements may be derived from at least two magnetic flux density measurements along a busbar at connection points (e.g., bar clips) to determine whether any of the units in the rack system is operating beyond system limits. To accurately measure and manage the current flow along the busbar, two sensors may be embedded in a bar clip connecting a power shelf positioned in the rack that supplies power to the busbar via the bar clip. The sensors may obtain measurements for the magnetic flux density generated by current flowing in at least two different directions (e.g., upwards along the busbar and downwards along the busbar).

Thus, by utilizing embedded hall sensors in a bar clip for a power shelf positioned in a rack system, magnetic flux density may be measured at different locations along a busbar and used to infer current flow along the busbar. Analysis of the current flowing upstream and downstream through each connector (e.g., bar clip) to a respective component of the rack system may be used to construct a topology of the rack's power distribution. By doing so, monitoring of power distribution may be facilitated to prevent overloading and overheating of the system. In addition, imbalances in current distribution may be detected and corrective actions may be performed in order to prevent potential damage to the system. Therefore, reliability in rack-mounted power systems may be improved by providing accurate current measurement without disrupting operations.

In an embodiment, a method for managing operation of a rack is provided. The method may include: obtaining current flow measurements of current along a length of a bus bar of the rack; identifying, using at least the current flow measurements, relative placements of data processing systems that draw power from the bus bar and power shelfs that supply power to the bus bar along the bus bar; making, using at least the relative placements, a determination regarding operation of the rack has exceeded system limits; in a first instance of the determination in which the rack has exceeded the system limits: obtaining, using at least the relative placements, a remediation plan; performing the remediation plan to update operation of the rack to prevent future operation of the rack from exceeding the system limits.

Identifying the relative placements may include: identifying, using the current flow measurements, a first data processing of the data processing systems as an end unit; identifying, using the current flow measurements, a second data processing system of the data processing systems as a neighbor unit for the first data processing system; and obtaining the relative placements based, at least, on the end unit and the neighbor unit.

Identifying the first data processing system may include: rank ordering the data processing systems using a portion of the current flow measurements; and selecting the first data processing system based on the rank ordering.

The portion of the current flow measurements may be a filtered set of the current flow measurements based on a current flow direction with respect to the bus bar.

The first data processing system may be selected for being associated with a smallest current flow measurement of the filtered set of the current flow measurements.

Identifying the second data processing system may include: identifying a first rate of current flow toward the first data processing system along the bus bar; identifying rates of current flow away from each other data processing system of the data processing systems; and making a determination that a rate of current flow of the current flow rates for the second data processing system is a closest rate to the first rate.

Obtaining the current flow measurements may include: obtaining a magnetic flux density measurement at a first position along the bus bar; and using the magnetic flux density measurement to identify a magnitude and a direction of current flow through the bus bar at the first position.

The magnetic flux density measurement may be obtained using a sensor of a bar clip of a data processing system of the data processing systems.

The bar clip may include a second sensor, the sensor and the second sensor being positioned to monitor a first current and a second current at different positions along the bus bar.

The different positions may be on opposite sides of the bar clip along the bus bar.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

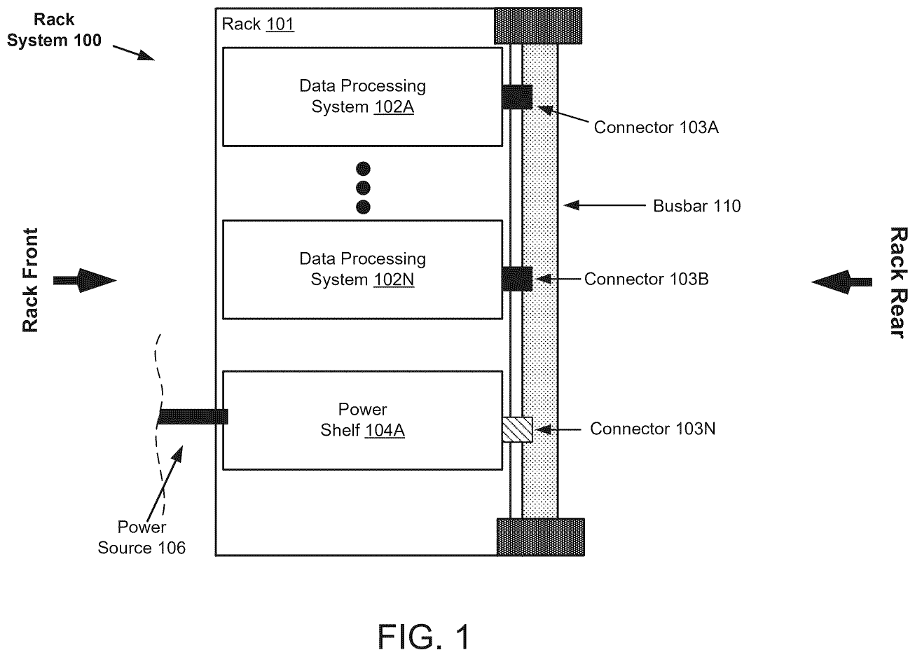

Turning to FIG. 1, a block diagram illustrating a system (e.g., rack system 100) in accordance with an embodiment is shown. The system shown in FIG. 1 may be a distributed system that provides computer implemented services.

These services may include any type and/or quantity of services. These services may include, for example, database services, data processing services, electronic communication services, and/or any other services that may be provided by one or more computing devices.

Other types of services may be provided by the system shown in FIG. 1 without departing from embodiments disclosed herein.

To provide these services, the system may include any number of data processing systems (e.g., computing devices), such as data processing systems 102A through 102N, positioned in a rack (e.g., 101) as shown in FIG. 1. Each of these data processing systems may include any quantity of hardware components. These components may include, for example, processors, memory modules, storage devices, communications devices, and/or any other type of component whose respective operation may facilitate various functionalities of the data processing systems. By facilitating such functionalities of the data processing systems, operation of any of these components may cause the services to be provided.

To enable such operation of the hardware components, the hardware components may consume power required for such operation. This power may be provided by one or more power supply units, such as any number of power supply units positioned in an enclosure (e.g., a chassis) of a power shelf. For example, this power shelf may be one of any number of power shelves (e.g., 104A through 104N) positioned in rack 101 that may collectively provide power to a power bus (e.g., busbar 110) positioned towards a rear of rack 101. This power bus, once provided the power, may redistribute the power to any number of chassis positioned in rack 101, each of these chassis at least partially housing at least one of the data processing systems.

However, the any number of power supply units and/or the power bus may be subjected to any number of unpredictable events, such as events that may negatively impact future distribution of power.

For example, should connections between the power bus and any of the chassis be deprecated and/or otherwise damaged, power components responsible for the distribution of power may become inefficient, unpredictable, and/or irreparable without significant and/or time-consuming replacements to the rack system. Consequently, should the power required for enabling such operation be inconsistently available (e.g., due to the deprecation and/or any occurrence of damage), if available at all, the data processing systems may not be capable of drawing power required to enable respective operation and/or may not be capable of otherwise providing the computer implemented services. Such services may thereby be delayed and/or prevented entirely.

To increase a likelihood of providing computer implemented services as expected and/or desired by a consumer of such services (e.g., an entity associated with the data processing systems in the rack), and decrease a likelihood of systems that may provide such services being negatively impacted, a distributed system (e.g., rack system 100) may include components such as those illustrated and discussed with regard to FIG. 1, below.

In general, embodiments disclosed herein relate to systems, devices, and methods for managing operation of a rack system. To do so, relative placements of data processing systems and power shelfs positioned within the rack system may be identified by using current flow measurements along a length of a busbar of the rack. The relative placements of the data processing systems and power shelfs may be used to determine whether operation of the rack has exceeded system limits.

To identify the relative placements of the components of the rack system (e.g., power shelfs, data processing systems, servers, etc.), electrical current measurements at discrete points along the bus bar may be obtained and analyzed. The electrical current measurements may be obtained using sensors at each node along the busbar and provided to a management unit of the rack system to generate a mapping of upstream and downstream current measurements of each node along the busbar. By doing so, the mapping of the upstream and downstream current flow measurements may be used to establish a topology of the components consuming electrical current via the busbar.

Therefore, by identifying the relative placements of the components positioned within the rack system and the current load distribution, management of the components of the rack system may be generated to remediate any occurrences of exceeding operational limits of the rack system. By doing so, a likelihood of a rack system (e.g., 100) being negatively impacted by exceeding system limits may be decreased and management of the power load distribution within the rack system may be optimized.

To provide the above noted functionality, the rack system of FIG. 1 (e.g., 100) may include rack 101, data processing systems 102A-102N, connectors 103A-103N, power shelf 104A, and/or busbar 110. Each of these is discussed below.

It will be appreciated that even though illustrated to include just two data processing systems (e.g., 102A and 102N), the system of FIG. 1 may include any number of data processing systems (e.g., 102A through 102N) not to be limited by embodiments discussed herein. Any of these systems may (i) include hardware components that consume power to facilitate respective operation, (ii) depend on a power source, such as one or more power shelves (e.g., 104A through 104N) and/or a power distributor (e.g., busbar 110), to provide the power, (iii) be stacked vertically with regard to one another in vertically aligned slots of rack 101, and (iv) provide computer implemented services based on respectively facilitated operation of the hardware components.

To provide their functionality, data processing systems 102A and 102N may be implemented by, for example, two computing devices such as servers positioned (e.g., stacked) vertically in rack 101 with one another. For example, the rack may include a series of slots that are vertically positioned relative to one another (e.g., the vertically aligned slots), and each data processing system may be at least partially housed in a respective chassis adapted to be inserted into one of the slots, each chassis being further adapted to house hardware components of a respective data processing system.

As mentioned above, these data processing systems (102A and 102N) may include management controllers. These management controllers may facilitate operation of the corresponding hardware components by (i) providing instructions/commands for the hardware components as well as (ii) facilitating communications with other devices.

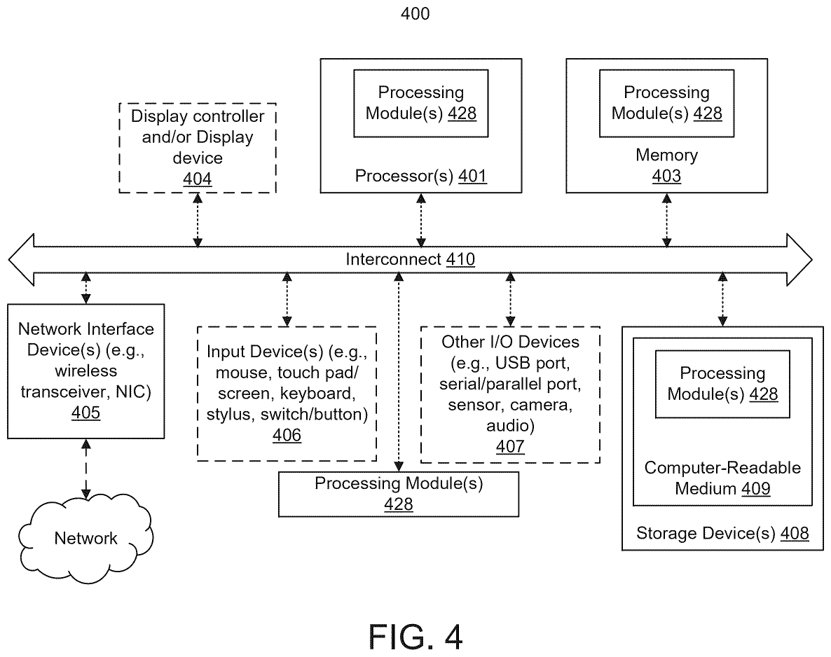

For additional information regarding data processing systems, refer to FIG. 4.

It will be appreciated that even though illustrated in FIG. 1 to include just one power shelf (e.g., 104A), the system of FIG. 1 may include any number of power shelves (e.g., 104A through 104N) not to be limited by embodiments discussed herein. Any of these power shelves may (i) include any number of power supplies, and (ii) provide power to the power bus (e.g., busbar 110).

To provide its functionality, power shelf 104A may be operably connected to power source 106 (e.g., any type of power source) and may be implemented by enclosures (e.g., other/additional chassis) adapted to house and secure power supply units that may be positioned within their respective interiors. These enclosures may also facilitate, at least in part, physical connection with, for example, the power bus (e.g., the power bus being positioned and adapted to relay (provide) power to the rest of rack system 100).

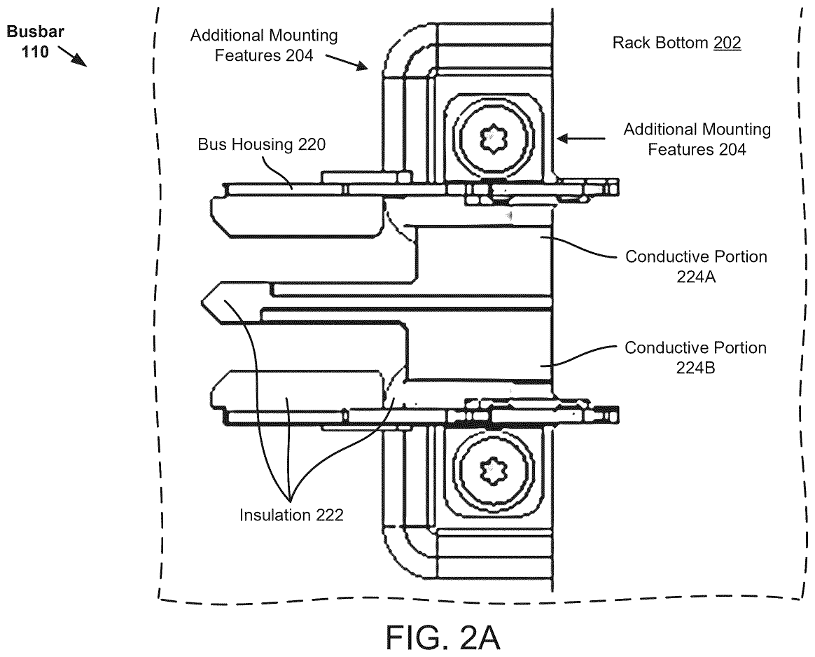

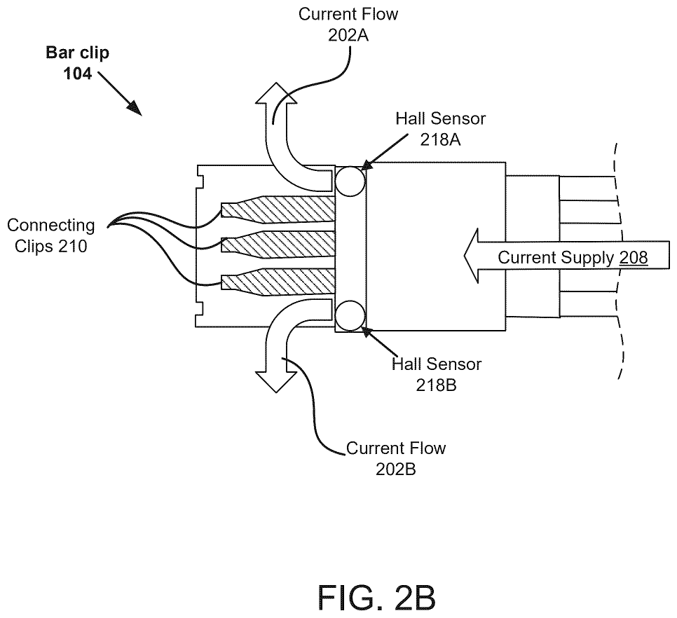

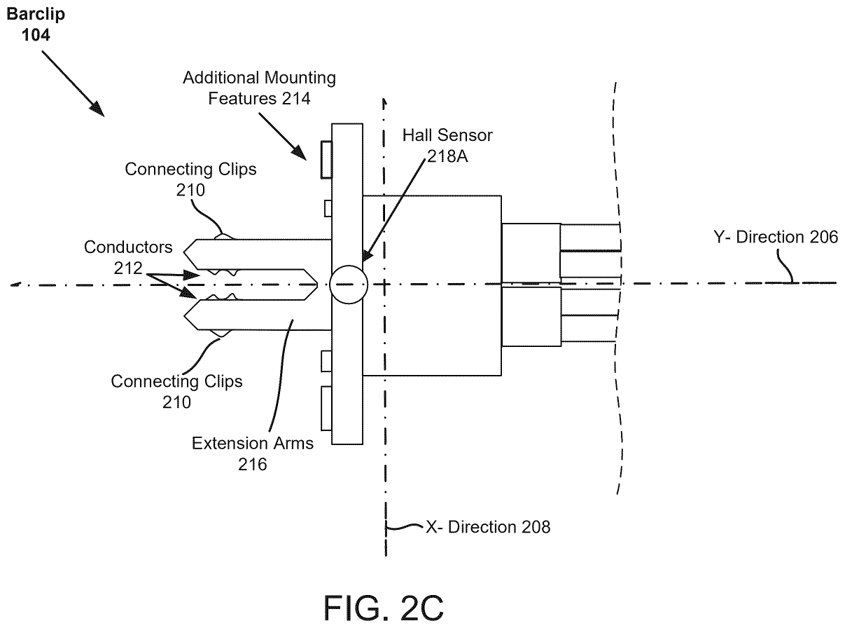

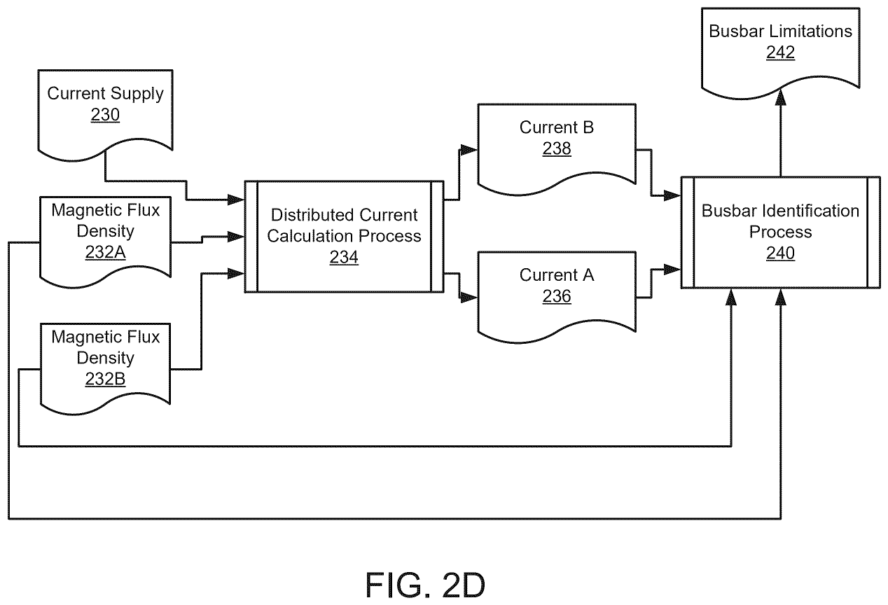

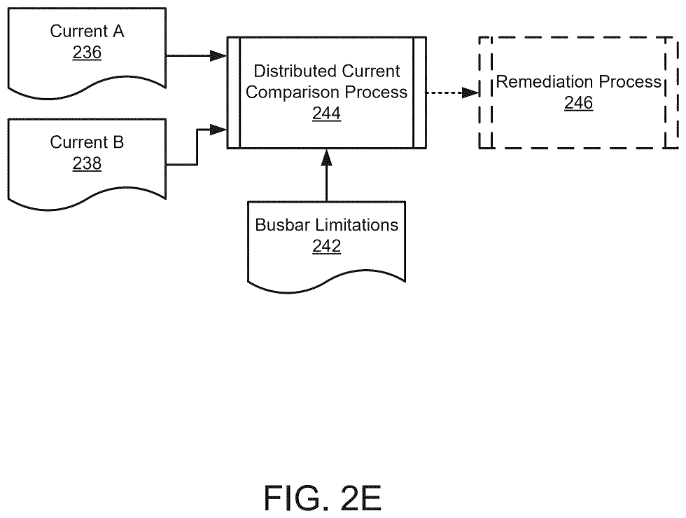

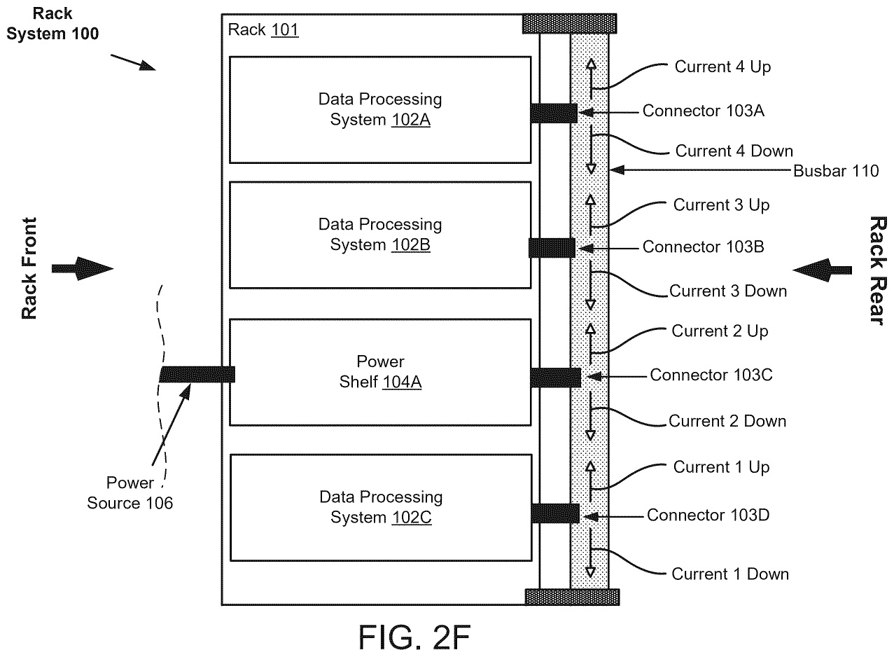

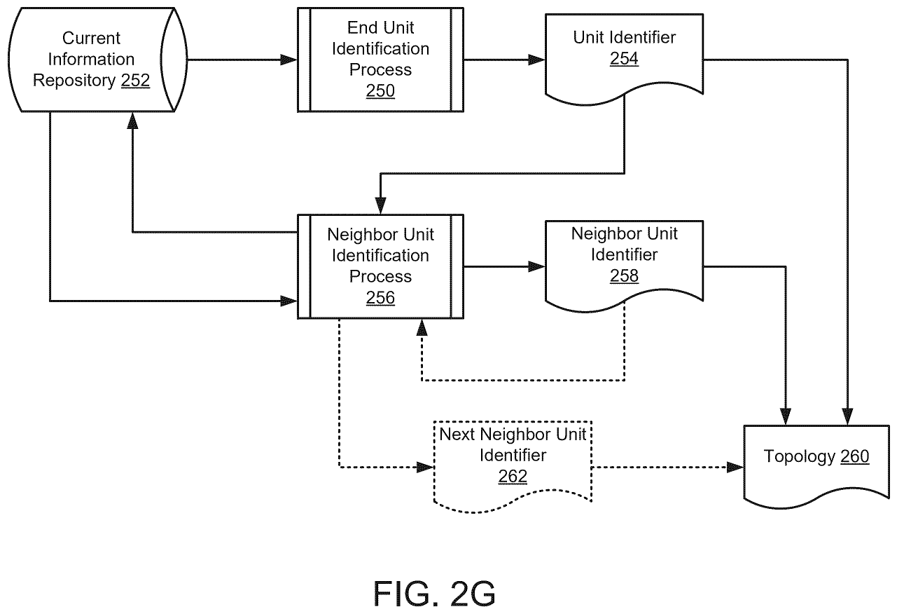

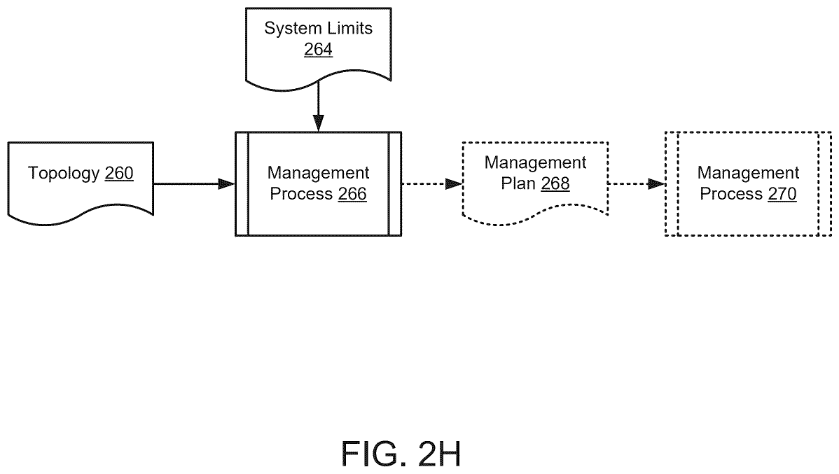

To further facilitate the connections between the power bus and the chassis housing the data processing systems and/or the other chassis housing power supply units, rack system 100 may include (i) first power connection (e.g., connector 103N) that enables the provision of power to the power bus from the power shelf, and (ii) second power connections (e.g., connectors 103A-103B) that enable distribution of the provided power to the data processing systems (e.g., that enable the hardware components to draw power as needed). Although referred in FIG. 1 as “connectors”, it may be appreciated that these power connections in rack system 100 may be referred as “bar clips” (e.g., bar clip 104). Refer to FIGS. 2B-2C for additional information regarding an individual bar clip.

It will be appreciated, that although discussed with regard to rack system 100 including these power connections, (i) any one of the first power connection may be included in, and/or may be extensions of, the other chassis housing power supply units, and (ii) any one of the second power connections may be included in, and/or may be extensions of, the chassis housing hardware components of the data processing systems.

To provide their functionalities, these power connections may be implemented by conductive materials shaped (and/or otherwise formed) to facilitate physical contact with other conductive materials so as to provide a path for power distribution between components of rack system 100, thereby contributing to the power buss'facilitation of power distribution throughout rack system 100.

The power bus (e.g., busbar 110) may, as previously discussed, (i) distribute power provided by the power shelves, (ii) enable the data processing systems (and therefore components thereof) to draw the power provided by the power shelves, and (iii) be positioned with the rear of rack 101.

To further facilitate the distribution of power, the power bus may (iv) be positioned in a first position wherein the power connections (e.g., 103A-103N) are in direct physical contact with busbar 110 while the chassis of both the data processing systems and the power shelves are in operable positions within rack 101 (e.g., positioned in slots of rack 101 and pushed towards the rack rear within those slots). For example, data processing systems 102A and 102N and power shelf 104A are depicted in FIG. 1 at their operable positions.

It will be appreciated that, as shown in FIG. 1, while in respective operable positions in rack 101, corresponding power connections of respective chassis may have physical contact with busbar 110. Alternatively, as shown in FIG. 1, a power connection (e.g., connector 103N) may not make physical contact with busbar 110 if a corresponding chassis (e.g., power shelf 104A) is not in its respective operable position, the operable positions being at the rear of rack 101 (e.g., placed into the slots and pushed a far toward the rear of rack 101 as possible).

As previously mentioned, however, power components such as the power supply units, power connections, and/or the power bus may be subjected to any number of unpredictable events, such as events (e.g., overload of the system) that may negatively impact future distribution of power.

For example, should connections between the power bus and any of the chassis, such as the power connections discussed above, be deprecated and/or otherwise take damage and/or inflict damage (e.g., inflict damage on busbar 110), power components such as the power bus may, with regard to power distribution functionality, become inefficient, unpredictable, and/or irreparable without significant and/or time-consuming replacements to the rack system.

Such deprecation and/or damage may, for example, occur during operation of rack system 100 (e.g., power being supplied to rack system 100). In such cases of the power distributing functionality being negatively impacted, rack system 100's capability of providing computer implemented services may result in such services instead being delayed and/or prevented entirely.

In an attempt to prevent such negative impacts, the power bus may also (v) be adapted for repositioning between the first position and a second position in which the power connections (e.g., 103A-103N) do not make physical contact with the power bus (e.g., busbar 110) while the chassis of both the data processing systems and the power shelves are in the operable positions within rack 101. To provide its functionality, the power bus may be implemented by busbar 110.

To facilitate the repositioning of the power bus between the first position and the second position, rack system 100 may further include relocation mechanism. For example, relocation mechanism may (i) enable detachment of the power bus from the first position and/or the second position such that the power bus may be repositioned, (ii) enable fixedly secure attachment of the power bus to the first position and/or the second position, and (iii) facilitate repositioning of the power bus while the power bus is not fixedly attached to either the first position and/or the second position.

To provide its functionality, relocation mechanism may be implemented by any number of mechanical component combinations that may facilitate fastening and/or repositioning of busbar 110 not to be limited by embodiments discussed herein. For example, relocation mechanism may be implemented by fasteners, sliding rails, bolts, hinges, locks, springs, etc.

It will be appreciated that relocation mechanism may include any number of sub-portions not to be limited by embodiments discussed herein. For example, these sub-portions may be separated by any distance from one another while still being part of rack system 100. For example, as shown in FIG. 1, relocation mechanism may include two sub-portions (e.g., a top sub-portion that is proximate to a rack ceiling of rack 101, and a bottom sub-portion that is proximate to a rack bottom of rack 101), each being located on opposite ends of busbar 110 from one another.

By including the aforementioned (e.g., discussed above) components, rack system 100 may enable the leveraging of the deployment framework. In doing so, the likelihood of the rack system providing the computer implemented services as intended once successfully deployed at the location (e.g., at which the services may be expected and/or desired) may thereby be increased.

For additional information regarding repositioning the power bus between the first position and the second position, refer to FIGS. 2A-2E further below.

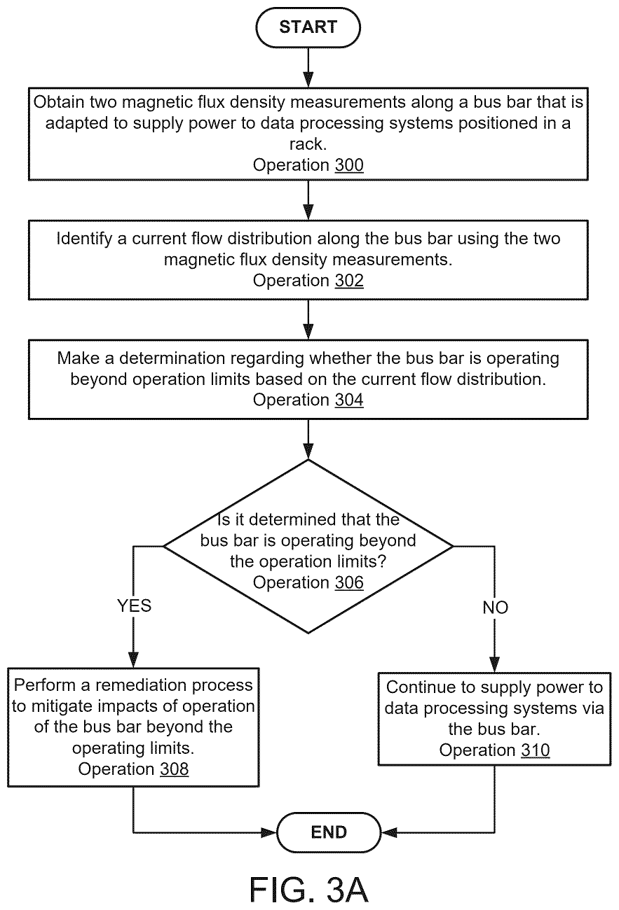

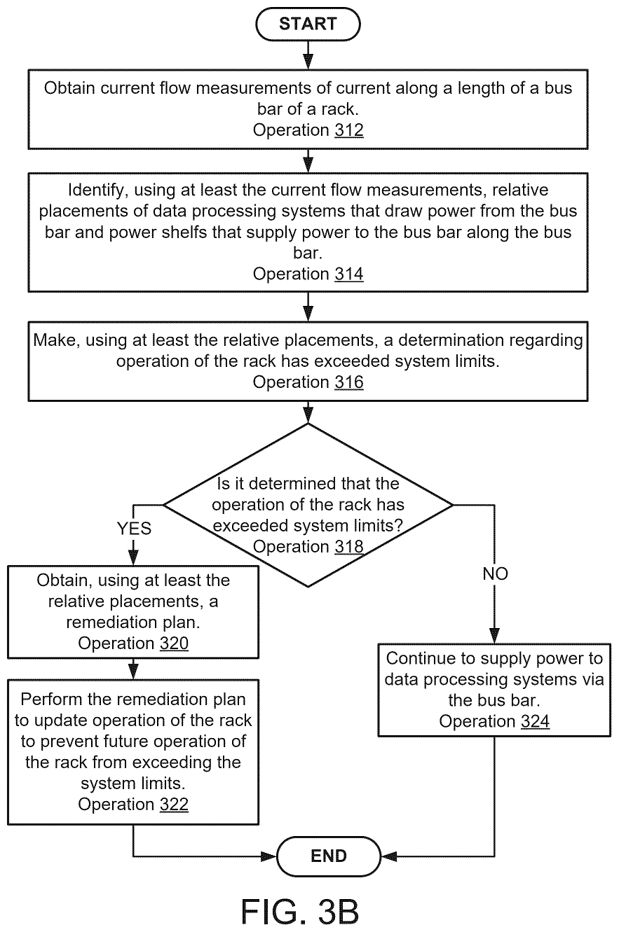

When providing their functionality, rack 101, data processing systems 102A-102N, connectors 103A-103N, power shelf 104A, and/or busbar 110 may perform (and/or be involved in) all, or a portion, of the method shown in FIG. 3.

Any devices (and/or components thereof) included in the system of FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system.

For additional details regarding computing devices, refer to FIG. 4.

Any of the components illustrated in FIG. 1 may be operably connected to each other (and/or components not explicitly illustrated) with a communication system utilized by data processing systems 102A-102N and/or other devices included in rack system 100.

In an embodiment, this communication system may include one or more networks that facilitate communication between any number of components. The networks may include wired networks and/or wireless networks (e.g., and/or the Internet). The networks may operate in accordance with any number and types of communication protocols (e.g., such as the internet protocol).

Thus, by utilizing embedded hall sensors in a bar clip for a power shelf positioned in a rack system, magnetic flux density may be measured at different locations along a busbar and used to infer current flow along the busbar. By doing so, monitoring of current distribution may be facilitated to prevent overloading and overheating of the system. In addition, imbalances in current distribution may be detected and corrective actions may be performed in order to prevent potential damage to the system. Therefore, reliability in rack-mounted power systems may be improved by providing accurate current measurement without disrupting operations.

While illustrated in FIG. 1 as including a limited number of specific components, a system (e.g., the rack system) in accordance with an embodiment may include fewer, additional, and/or different components than those illustrated therein.

To further clarify embodiments disclosed herein, diagrams illustrating examples of a rack system (and/or portions thereof) in accordance with embodiments are shown and discussed with regard to FIG. 2A. Furthermore, diagrams illustrating examples of a bar clip in accordance with embodiments are shown and discussed further below with regarding to FIGS. 2B-2E.

Turning to FIG. 2A, a structural diagram in accordance with an embodiment is shown. The structural diagram may illustrate a top-down view (with a top side of rack bottom 202 facing out of the page and the rack rear facing a bottom of the page) of that depicted in FIG. 1. This top-down view may be used to clarify an orientation of busbar 110 with an embodiment.

For example, while in the second position (e.g., transitory position 210), busbar 110 may be oriented such that the housing of busbar 110 may be fasten-able via the bolts and/or bolt holes of additional mounting features 204. These bolts and bolt holes may be used to, for example, fixedly secure the bottom of busbar 110 into the page, and therefore, fixedly secure busbar 110 to rack bottom 202.

Additionally, conductive surfaces of busbar 110 may not face directly toward the power connections (positioned outside a viewpoint of FIG. 2G and toward a top of the page) as they would normally do when busbar 110 is in functional position to facilitate the distribution of power when the power connections make physical contact with busbar 110. This may be due to the conductive surfaces of busbar 110 needing to face the power connections should physically contact with the power connections be intended/required.

For example, to provide its functionality, busbar 110 may include bus housing 220, insulation 222, conductive portion 224A, and conductive portion 224B. Each of these is discussed below.

As previously discussed, the housing of busbar 110 may be fasten-able via the bolts and/or the bolt holes of additional mounting features 204. For example, this housing may be implemented by bus housing 220.

Bus housing 220 may, for example, (i) at least partially house insulating and/or conductive materials of busbar 110, (ii) provide a stable (e.g., unmalleable) structure for busbar 110, the structure being adapted to maintain a relative shape of busbar 110 (e.g., before, during, and after deployment), (iii) have a general shape, extended members, and/or other characteristics adapted to interact with relocation mechanism 112 to facilitate attachment and/or detachment of busbar 110 to and/or from rack bottom 202, (iv) facilitate and/or prevent deliberate (e.g., specific) physical contact between housed portions of busbar 110 and the power connections based on a position of busbar 110 and positions of the chassis in rack 101.

To provide its functionality, bus housing 220 may be implemented by an enclosure that at least partially surrounds the insulating and conductive portions of busbar 110. For example, bus housing 220 may be of a same material as that of the chassis positioned in rack 101.

Insulation 222 may include any number of materials positioned between bus housing 220 and the conductive portions of busbar 110. For example, the insulating materials may be adapted to prevent an electrical current from traveling between bus housing 220 and the conductive portions, thereby limiting a traversal path of any electrical current traversing through busbar 110 to an intended and/or predictable path. For example, by being limited to this path, an entity (and/or other components in a shared environment of the rack system) may be less likely to be negatively impacted in a physical manner (e.g., a manner resulting in injuries to the client and/or damages to the rack system).

To provide its functionality, insulation 222 may be implemented by insulating materials that prevent and/or are otherwise maladapted for conducting electricity.

Conductive portions 224A and 224B may obtain power provided by the power shelves and/or distribute that power throughout the rack system. For example, conductive portion 224A may be adapted to facilitate the obtaining of the power, and conductive portion 224B may be adapted to redistribute the obtained power to the data processing systems in rack 101.

It will be appreciated that, while power is being collaboratively distributed by these conductive portions, any one of the two conductive portions may be the actual (and sole) distributor of the obtained power while the other of the two conductive portions may be the sole facilitator of the obtaining of the power in an embodiment.

To provide their functionalities, conductive portions 224A-224B may be implemented by conductive materials that promote and/or may otherwise be adapted for conducting electricity.

Turning to FIG. 2B, a first diagram illustrating a side view of a bar clip (e.g., 104, an example of the previously mentioned bar clip) in accordance with an embodiment is shown.

Bar clip 104 may facilitate power distribution by providing a secure connection between a bus bar (e.g., bus bar 110) and a power supply (e.g., power shelf 104A shown in FIG. 1). For example, bar clip 104 may provide electricity supplied by a power shelf (e.g., power shelf 104A shown in FIG. 1 as previously mentioned) to busbar 110.

To securely connect to busbar 110, bar clip 104 may include connecting clips 210. Connecting clips 210 may align with the tips of the busbar (e.g., bus housing 220 of busbar 110 shown in FIG. 2A) such that bar clip 104 may be adapted to fasten to busbar 110. Connecting clips 210 may include, for example, a clamping feature designed to securely fix opposing interconnects for two extension pole connections of busbar 110 to extension arms 216 of bar clip 104. Refer to FIG. 2C for additional details regarding connecting clips of a bar clip.

To facilitate the distribution of power to the data processing systems via the power bus (e.g., busbar 110), a supply of current (e.g., current supply 208) may flow from the power shelf (e.g., power shelf 104A) into bar clip 104. Current supply 208 may enter bar clip and flow in multiple directions. The actual current flowing through different sections of the busbar may vary depending on the distribution of load across the rack. For example, if the power shelf is positioned in the middle of the rack (e.g., with data processing systems positioned above and below the power shelf), the current flow may split into two directions, with one current flow directed above the bar clip (e.g., current flow 202A as indicated by the direction of the arrow pointing upward toward the top of the paged) and a second current flow directed below the bar clip (e.g., current flow 202B as indicated by the direction of the arrow pointing downward toward the bottom of the page).

Measuring the total current coming out of the power shelf may not indicate how the current is distributed along busbar 110, thereby increasing the difficulty in preventing overloads and increasing a likelihood of causing damage to the system. To accurately measure (and therefore manage) the current flow distributed along the busbar, bar clip 104 may include sensors positioned on opposite sides of a current injection point (e.g., point of current supply 208 via power shelf 104A). The sensors may include, for example, hall sensors (e.g., hall sensors 218A & 218B) embedded in bar clip 104 to measure the magnetic flux density generated by respective currents at two different distributions points.

For example, hall sensor 218A may be positioned at the top of bar clip 104 in order to measure the magnetic flux density generated by the flow of current directed upwards (e.g., above the current injection point). For example, if the current flow is directed upwards, a first measurement of the magnetic flux density generated may rotate in a counter-clockwise motion relative to the z-axis.

Hall sensor 218B may be positioned at the bottom of bar clip 104 in order to measure the magnetic flux density generated by the flow of current directed downwards (e.g., below the current injection point). For example, if the current flow is directed downwards, a second measurement of the magnetic flux density generated may rotate in a clockwise motion relative to the z-axis.

The rate of current injection (e.g., current from the power shelf) and the two measurements of magnetic flux density may be used to calculate a first current flow rate and first current flow direction (e.g., current flow 202A) and a second current flow rate and second current flow direction (e.g., current flow 202B). For example, the difference between the magnitudes (e.g., of the magnetic flux density measurements obtained from the sensors) may provide the correct magnetic flux density contribution of the current flowing in busbar 110 resulting from current supply 208. The sensors (e.g., hall sensor 218A and 218B) may measure the magnetic flux density (“B”) which may be proportional to the current (“I”) flowing through the busbar 110 at the respective locations of the bar clip..

Current flow 202A and current flow 202B may be used to obtain the current flow distribution (e.g., the distribution of current) along busbar 110. For example, to determine current distribution, Maxwell's equations as specified below may be used to derive the actual current flowing through each segment of busbar 110.
I₁ may be the total current from the power shelf.
I₂ may equal the current flowing up the busbar.
I₃ may equal the current flowing down the busbar.

Conservation of current: I₁=I₃−I₂.
B2 may be the magnetic flux density measured by hall sensor 218A.
B3 may be the magnetic flux density measured by hall sensor 218B.
Noise provided by common mode sources (CM) may be considered.
k may be a constant related to the busbar type/size (e.g., providing rate capacity)

B2=k*I₂+CM noise

B3=k*I₃+CM noise

B3−B2=k*I₃−k*I₂+CM noise−CM noise

k*(I₃−I₂)=k*I₁

k=(B3−B2)/I₁

If the sensors (e.g., hall sensor 218A and 218B) detect that either I₂ and/or I₃ exceeds the busbar's rate capacity, a remedial action may be triggered. Refer to FIG. 2E for additional information regarding performing remediation processes.

Turning to FIG. 2C, a second diagram illustrating a top-down view (with a top side of bar clip 104 facing out of the page, the rear side of bar clip 104 facing into the page, and a backside of the bar clip 104 facing the right side) of that depicted in FIG. 2B. This top-down view may be used to clarify an orientation of hall sensors (e.g., hall sensors 218A & 218B) positioned within the bar clip (e.g., bar clip 104) with an embodiment.

As previously discussed, bar clip 104 may facilitate power distribution by providing a secure connection between a bus bar (e.g., bus bar 110) and a power supply (e.g., power shelf 104A shown in FIG. 1). To securely connect to busbar 110, connecting clips 210 may align with the tips of the busbar (e.g., bus housing 220 of busbar 110 shown in FIG. 2A) such that bar clip 104 may be adapted to fasten to busbar 110. Connecting clips 210 may include, for example, a clamping feature designed to securely fix opposing interconnects for two extension pole connections of busbar 110 to extension arms 216 of bar clip 104.

Bar clip 104 may also include conductors 212 positioned along an inside portion of extension arms 216. Conductors 212 may be integrally formed within both internal sides of extension arms 216. Conductors 212 may include, for example, any type of high-conductivity materials (e.g., copper, aluminum, etc.) designed for high-current applications. When busbar 110 is connected to bar clip 104, conductors 212 may provide the incoming electrical current (e.g., current supply 208) from the power shelf to the busbar 110 (e.g., via conductive portion 224A-224B of busbar 110 as shown in FIG. 2A).

To further clarify embodiments disclosed herein, data flow diagrams in accordance with an embodiment are shown in FIGS. 2D-2E. In these diagrams, flows of data and processing of data are illustrated using different sets of shapes. A first set of shapes (e.g., 230, 238, etc.) is used to represent data structures, and a second set of shapes (e.g., 234, 240, etc.) is used to represent processes performed using and/or that generate data.

Turning to FIG. 2D, a first data flow diagram illustrating data flows, data processing, and/or other operations that may be performed by the system of FIG. 1 in accordance with an embodiment is shown. The data flows, data processing, and/or other operations may be performed to identify a bus bar type used in a rack system.

To identify the bus bar type, distributed current calculation process 234 may be performed. During distributed current calculation process 234, current supply 230, magnetic flux density 232A, and magnetic flux density 232B may be used to identify the current flow distribution (e.g. along the bus bar).

Magnetic flux density 232A and magnetic flux density 232B may include a measurement of the magnetic flux density (e.g., strength of a magnetic field) proximate to the respective sensors (e.g., hall sensors 218A and 218B, respectively, as shown in FIG. 2B).

As a result of performing distributed current calculation process 234, the current flowing at two points along the busbar (e.g., above the current injection point and below the current injection point) may be calculated. For example, the magnetic flux density 232A (e.g., measured by hall sensor 218A) generated by a current flow upwards along the busbar may be proportional to a first current flow rate in a first current flow direction (e.g., represented by current A 236). In addition, the magnetic flux density 232B (e.g., measured by hall sensor 218B) generated by a current flow upwards along the busbar may be proportional to a second current flow rate in a second current flow direction (e.g., represented by current B 238).

Current A 236 and Current B 238 may be used to perform busbar identification process 240. During busbar identification process 240, the type and/or size of busbar (e.g., busbar 110) may be identified using the two magnetic flux density measurements and the current flow distribution. For example, magnetic flux density 232A, magnetic flux density 232B, current A 236, and current B 238 may be used in any type of look up process where the busbar type/depth (e.g., cross section) is determined based on a relationship between the current and magnetic flux density. For example, a lookup table may include predefined relationships between the measurement parameters (e.g., magnetic flux density being proportional to the current, and a function of a cross section (e.g., depth) of the bus bar) based on the formulas described above in FIG. 2B. By using the measured current, for example, 2500 Amps, and the measured magnetic flux density, for example, 0.8 milliTesla (mT), as keys to perform a lookup using the look up table (e.g., defining the relationship between bus bar depth and the magnetic flux density and current), the size (e.g., depth) of the bus bar may be identified (e.g., 22 millimeter deep).

By performing busbar identification process 240, busbar limitations 242 may be identified. Busbar limitations 242 may include operation limits based on the type of busbar. The operation limits may include a maximum current the busbar may safely carry continuously without exceeding its temperature rating. Exceeding the operation limit may cause overheating, insulation degradation, and/or potential fire hazards.

Turning to FIG. 2E, a second data flow diagram illustrating data flows, data processing, and/or other operations that may be performed by the system of FIG. 1 in accordance with an embodiment is shown. The data flows, data processing, and/or other operations may be performed during identifying whether a bus bar is operating beyond operation limits.

To identify whether the bus bar is operating beyond operation limits, distributed current comparison process 224 may be performed. During distributed current comparison process 224, a current flow distribution may be compared to the operation limits of the bus bar to determine whether the operation limits have been exceeded.

To do so, the current flow distribution may be obtained by using the rate of current injection (e.g., into the bus bar by the power shelf) and the two magnetic flux density measurements (e.g., magnetic flux density 232A & 232B) to calculate (i) a first current flow rate and first current flow direction (e.g., current A) above the current injection point, and (ii) a second current flow rate and second current flow direction (e.g., current B) below the current injection point.

As a result of performing distributed current comparison process 244, a determination regarding whether the bus bar is operating beyond operation limits may be made. For example, if the power shelf is positioned in the middle of a rack with data processing systems positioned above and below the respective power shelf, the current may split evenly into the upper and lower sections of the busbar. If 1000 amperes (“A”) is injected from the power shelf to the busbar (e.g., via the bar clip), 500 A may flow upwards along the busbar and 500 A may flow downwards along the busbar. In this scenario, it may be determined that the busbar is operating within the operating limits.

If the bus bar is operating beyond the operation limits (e.g., the current flow distribution exceeds the current load limits for the bus bar), remediation process 246 may be performed. For example, assuming the power shelf is positioned at the bottom of a rack with data processing systems positioned above the power shelf (e.g., all current may flow upwards to power the chassis units), if 1500 amperes (“A”) is injected but the busbar is rated for 1200 A maximum, an increase in heat production may occur (e.g., overheating).

During remediation process 246, any type of process to remediate exceeding the operation limit of the bus bar. For example, remediation process 246 may include: (i) establishing a limit on operation of the rack (e.g., based on an inferred damage to the rack due to the current distribution exceeding a transient limit, (ii) obtaining a health map of the rack (e.g., compilation of historical information regarding the health of the rack and the inferred damage), (iii) issuance of warnings to an external device (e.g., operated by an administrator and/or operator of the rack system) regarding the current distribution exceeding the operation limits, (iv) initiate replacement of the bus bar (e.g., physical replacement) with a different bus bar (e.g., properly sized/type of bus bar for the desired current distribution), and/or (v) any other type of processes to remediate the consequences of exceeding the operation limits of the bus bar.

Establishing a limit on operation of the rack may include, for example, decreasing the current load flowing through the bus bar (e.g., by decreasing the current supplied by the power shelf). For example, a restriction on the amount of current that may flow through specific parts of the busbar may be implemented. As additional example, power delivery to certain chassis units may be temporarily reduced to lower total current flow.

As part of performing remediation process 246, a determination regarding whether an operation limit exceeded by the bus bar is a continuous limit and if so, monitoring the current distribution transitorily may be performed to identify whether a transient limit corresponding to the continuous limit has been exceeded. For example, once an operation limit has been exceeded, a determination to classify the limit may be made. For example, real-time monitoring of the current distribution may identify instances where a continuous limit may be exceeded. A continuous limit violation may indicate a sustained overload condition which may lead to overheating and electrical fires if not addressed. If the measured current exceeds the continuous limit remediation actions may be immediately performed. A transient limit may be a temporary threshold that helps detect short-duration spikes in the current flow. If the measured current exceeds a transient limit, additional monitoring may be performed to check if the transient condition persists. For example, if the current exceeds the operation limits for a duration of time that exceeds the transient limit, at least one additional remediation process may be performed. By doing so, a recurring or worsening overload condition may be addressed in order to prevent damage or system failure.

Turning to FIG. 2F, a system diagram illustrating data flows, data processing, and/or other operations that may be performed by the system of FIG. 1 in accordance with an embodiment is shown. The data flows, data processing, and/or other operations may be performed during identifying whether a rack system is operating beyond system limits.

To provide the above noted functionality, similar to the rack system of FIG. 1, the rack system of FIG. 2F (e.g., 100) may include rack 101, data processing systems 102A-102C, connectors 103A-103D, power shelf 104A, and/or busbar 110. Each of these is discussed below.

It will be appreciated that even though illustrated to include just three data processing systems (e.g., 102A, 102B, and 102C), the system of FIG. 2F may include any number of data processing systems (e.g., 102A through 102N) not to be limited by embodiments discussed herein. Any of these systems may (i) include hardware components that consume power to facilitate respective operation, (ii) depend on a power source, such as one or more power shelves (e.g., 104A through 104N) and/or a power distributor (e.g., busbar 110), to provide the power, (iii) be stacked vertically with regard to one another in vertically aligned slots of rack 101, and (iv) provide computer implemented services based on respectively facilitated operation of the hardware components.

Multiple current measurements along a busbar (e.g., busbar 110) may be used to determine a relative positioning of data processing systems (e.g., 102A-102C) and power shelf (e.g., 104A) within rack system 100. The current measurements may be derived from magnetic flux density measurements using hall sensors embedded in the bar clips (e.g., connectors 103A-103D), which provide power to each respective data processing system and/or power shelf via the busbar 110. By analyzing the current flowing in an upstream direction and a downstream direction (e.g., along the z-axis) through each connecting point (e.g., via connectors 103A-103D), the system may generate a topology of the rack system's power distribution. By doing so, the topology of the rack system's power distribution may be analyzed to identify if the system limits (e.g., maximum current flow limitations for the busbar) have been exceeded and if so, which of the data processing systems may be the cause of the violation in the system limits.

As described above, each bar clip may include hall effect sensors positioned to measure the upstream current (e.g., current A 236 shown in FIG. 2E) and the downstream current (e.g., current B 238 shown in FIG. 2E). Refer to FIG. 2D for additional information regarding calculation of the distributed current along a busbar.

Using the current flow measurements, the relative positioning of the data processing systems (e.g., 102A-102C) may be obtained. For example, all the upstream currents (e.g., as represented by “current 1 up”, “current 2 up”, “current 3 up”, and “current 4 up” and downstream currents (e.g., as represented by “current 1 down”, “current 2 down”, “current 3 down”, and “current 4 down”) may be provided to a management unit (e.g., a management controller and/or a separate data processing system) to identify a downstream current equaling zero at a point along the busbar (e.g., identifying a respective, first data processing system of the rack system).

For example, the relative lowest unit of rack system 100 may be identified by locating the connection to the busbar where the downstream current is zero, which corresponds to an end unit in the system. For example, as shown in FIG. 2F, “current 1 down” may be approximately equivalent to zero, and as such, data processing system 102C may be identified as the end unit of the rack system. Refer to FIG. 2G for additional information regarding end unit identification process 250.

By iterating upwards (e.g., identify a downstream current measurement approximately equivalent to the upstream of the identified end unit), the system may identify the neighboring unit (e.g., data processing system and/or power shelf) positioned relatively to the end unit and/or the next neighboring unit above it, allowing for a complete mapping of all connected components of the rack system.

Turning to FIG. 2G, a third flow diagram illustrating data flows, data processing, and/or other operations that may be performed by the system of FIG. 2F in accordance with an embodiment is shown. The data flows, data processing, and/or other operations may be performed during topology identification for data processing systems positioned in a rack.

To identify the topology, end unit identification process 250 may be performed. During end unit identification process 250, a repository with current information (e.g., current information repository 254) may be analyzed to identify an end unit of the data processing systems. The end unit may be a first data processing system selected for being associated with the smallest current flow measurement of a set of current flow measurements. For example, any type of searching process may be performed to identify the downstream current that is (approximately) equivalent to zero.

Current information repository 252 may include the distributed current measurements (e.g., upstream and downstream current measurements) for each bar clip connected to a busbar of the rack system. For example, as shown in FIG. 2F, current information repository 252 may include the upstream current (“current 1 up”) and the downstream current (“current 1 down”) measured at connector 103D, the upstream current (“current 2 up”) and the downstream current (“current 2 down”) measured at connector 103C, the upstream current (“current 3 up”) and the downstream current (“current 3 down”) measured at connector 103B, the upstream current (“current 4 up”) and the downstream current (“current 4 down”) measured at connector 103A, and/or any other current flow measurements for additional bar clips for respective data processing systems/power shelves in a rack system.

As a result of performing end unit identification process 250, a unit identifier 254 may be obtained. Unit identifier 254 may include information identifying the relatively lowest positioned unit in the rack system. For example, unit identifier 254 may include information identifying data processing system 102C as the end unit of rack system 100 (e.g., as shown in FIG. 2F).

After identifying the end unit of the system, neighbor unit identification process may be performed. During neighbor unit identification process 256, downstream and upstream currents may be matched to determine adjacent/neighboring units (e.g., neighbor unit identifier 258). For example, upstream current of the end unit may be used to identify the downstream current that is approximately equivalent to one another. For example, the upstream current measured at connector 103D (e.g., current 1 up) may be equivalent to the downstream current measured at connector 103C (e.g., current 2 down).

By performing neighbor unit identification process 256, neighbor unit identifiers 258 may be generated to define interconnections of the components of the rack system. Neighbor unit identifier 258 may include any type of information necessary to identify the component (e.g., data processing system, power shelf, etc.) of the rack system that is neighbor the last identified unit. Neighbor unit identification process 256 may be performed using the neighbor unit identifier for each data processing system and/or power shelf until all of the relative placement for each of the units (e.g., data processing systems and/or power shelves) in the system have been identified.

Each of the identifiers for the units in the system (e.g. including unit identifier 254, neighbor unit identifier 258, and/or next neighbor unit identifier 262) may be used to obtain topology 260. By using the ordered neighbor relationships, a complete topology of a rack system may be obtained. For example, using the identifiers for the units relative to other units in the system, a topology of the components within the rack system may be generated. Topology 260 may include the relative positioning of data processing systems and/or power shelves in the rack system.

Turning to FIG. 2H, a fourth flow diagram illustrating data flows, data processing, and/or other operations that may be performed by the system of FIG. 2F in accordance with an embodiment is shown. The data flows, data processing, and/or other operations may be performed during management of data processing systems positioned in a rack.

To manage the data processing systems, management process 266 may be performed. During management process 266, the topology information (e.g., topology 260) may be compared to the limitations of the system (e.g., system limits 264) to identify any power distribution violations (e.g., such as exceeding system limits). For example, if a data processing system is drawing 450 A of current and the system limitations is 400 A of total current flowing along the busbar, the system limits may be exceeded (e.g., a violation in the power distribution of the system).

If any of system limits 264 have been violated, a management plan (e.g., management plan 268) may be generated to remediate the violations. The management plan (e.g., 268) may be used to drive the management process (e.g., management process 270) to fix the operations of the system.

Management plan 268 may include, for example: (i) identifying the data processing systems that are consuming an excess amount of power compared to the system limits, and (ii) reducing the power consumption by specific data processing systems so that system limits 264 are not violated.

Management plan 268 may be used to perform management process 270. During management process 270, any type of process to remediate exceeding the operation limit of the system. For example, remediation process 246 may include: (i) generating recommendations of re-positioning components of the rack system (e.g., power shelves, data processing systems, etc.) in a manner that optimizes the load distribution along the busbar, (ii) establishing a limit on operation of the rack (e.g., based on an inferred damage to the rack due to the current distribution exceeding a transient limit, (iii) obtaining a health map of the rack (e.g., compilation of historical information regarding the health of the rack and the inferred damage), (iv) issuance of warnings to an external device (e.g., operated by an administrator and/or operator of the rack system) regarding the current distribution exceeding the operation limits, (v) initiate replacement of the bus bar (e.g., physical replacement) with a different bus bar (e.g., properly sized/type of bus bar for the desired current distribution), and/or (vi) any other type of processes to remediate the consequences of exceeding the operation limits of the bus bar.

Management process 270 may include, for example, sending instructions to the data processing systems to limit the power consumed by the respective data processing systems. By doing so, the violations to the system limits may be reduced and a likelihood of the negative impacts of the operation of the system may be decreased.

While illustrated in FIGS. 2A-2H with a limited number of specific components, a system (e.g., a rack system) may include additional, fewer, and/or different components without departing from embodiments disclosed herein.

As discussed above, the components of FIGS. 1-2H may facilitate and/or perform various functionalities to manage a system that may include a rack for housing data processing systems. Managing operation of the rack may include measuring and managing electrical current distribution specifically when using a busbar for power distribution.

As discussed above, the components of FIGS. 1-2H may facilitate and/or perform various functionalities to manage operation of a rack. FIGS. 3A-3B illustrates a method that may be facilitated and/or performed by the components of FIGS. 1-2H.

In the diagrams discussed below and shown in FIGS. 3A-3B, any of the operations may be repeated, performed in different orders, and/or performed in parallel with or in a partially overlapping in time manner with other operation.

Turning to FIG. 3A, a first flow diagram illustrating a method for deploying computing resources to a location in accordance with an embodiment is shown. The method may be performed, for example, by a rack system (e.g., 100) and/or any other entity.

At operation 300, two magnetic flux density measurements along a bus bar that is adapted to supply power to data processing systems positioned in a rack may be obtained. The two magnetic flux density measurements may be obtained via (i) using two sensors embedded in a bar clip for a power shelf positioned in the rack that supplies power to the bus bar via the bar clip.

At operation 302, a current flow distribution along the bus bar may be identified using the two magnetic flux density measurements. Identifying the current flow distribution along the bus bar may include: (i) identifying a rate of current injection into the bus bar by the power shelf while the two magnetic flux density measurement are obtained, (ii) using at least the rate and the two magnetic flux density measurements to calculate a first current flow rate and first current flow direction above the current injection point and a second current flow rate and second current flow direction below the current injection point to obtain the current flow distribution, and/or (iii) any other methods.

Identifying the current flow distribution may also include: identifying current flow along the bus bar at discrete locations corresponding to where the bar clips for the data processing system are positioned with respect to the bus bar. For example, each of the bar clips may include sensors for making discrete measurement of the magnetic flux density proximate to the respective sensors.

Identifying the rate of current injection into the bus bar by the power shelf may be facilitated by using the two sensors (e.g., positioned on opposite sides of the current injection point along the bus bar) to obtain the rate of current injection.

Using at least the rate and the two magnetic flux density measurements may be used to calculate (i) the first current flow rate and the first current flow direction above the current injection point and (ii) the second current flow rate and second current flow direction below the current injection point by (i) identifying a difference between the two magnetic flux density (e.g., via subtracting the two magnetic flux density measurements), (ii) dividing the difference between the two magnetic flux density and the rate of current injection.

At operation 304, a determination regarding whether the bus bar is operating beyond operation limits may be made. The determination may be made based on the current flow distribution. Making the determination may include: (i) identifying a type of the bus bar using the two magnetic flux density measurements and the current flow distribution, (ii) identifying the operation limits based on the type of the bus bar, and/or (iii) comparing the current flow distribution to the operating limits to make the determination.

If it is determined that the bus bar is operating beyond the operation limits (e.g., if the determination is “YES” at operation 306), then the method may proceed to operation 308.

At operation 308, a remediation process to mitigate impacts of operation of the bus bar beyond the operating limits may be performed. Performing the remediation process may include: (i) making a second determination regarding whether an operation limit of the operation limits exceeded by the bus bar is a continuous limit; in a first instance of the second determination where the operation limit is a continuous limit: identifying a transient limit corresponding to the continuous limit; transitorily monitoring the current distribution; in a first instance of the transitorily monitoring where the current distribution does not exceed the transient limit: concluding that no additional remediation is to be performed; and in a second instance of the transitorily monitoring where the current distribution exceeds the transient limit: concluding that at least one additional remediation process is to be performed.

The method may end following operation 308.

Returning to operation 306, if it is determined that the bus bar is not operating beyond the operation limits (e.g., the determination is “NO” at operation 306), then the method may proceed to operation 310. At operation 310, operation of the bus bar may continue.

The method may end following operation 310.

Turning to FIG. 3B, a second flow diagram illustrating a method for managing operations of a rack in accordance with an embodiment is shown. The method may be performed, for example, by a rack system (e.g., 100) and/or any other entity.

At operation 312, current flow measurements of current along a length of a bus bar of a rack may be obtained. The current flow measurement of the current may be obtained by (i) identifying a rate of current injection into the bus bar by the power shelf while the two magnetic flux density measurement are obtained, (ii) using at least the rate and the two magnetic flux density measurements to calculate a first current flow rate and first current flow direction above the current injection point and a second current flow rate and second current flow direction below the current injection point to obtain the current flow distribution, and/or (iii) any other methods.

At operation 314, relative placements of data processing systems that draw power from the bus bar and power shelfs that supply power to the bus bar along the bus bar may be identified. The relative placements of the data processing systems and the power shelfs may be identified by: (i) using the current flow measurements for each connector (e.g., bar clip) coupled to the busbar, (ii) performing a matching processing using the current flow measurements to identify neighboring units respective to one another, and/or (iii) any other methods.

Identifying the relative placements of data processing systems and power shelfs may include: (i) identifying, using the current flow measurements, a first data processing system of the data processing systems as an end unit, (ii) identifying, using the current flow measurements, a second data processing system of the data processing systems as a neighbor unit for the first data processing system, (iii) obtaining the relative placements based, at least, on the end unit and the neighbor unit, and/or (iv) any other methods.

Identifying the first data processing system may include: (i) rank ordering the data processing systems using a portion of the current flow measurements, and (ii) selecting the first data processing system based on the rank ordering.

Rank ordering the data processing systems may include ordering the data processing systems based on the current flow measurements from a lowest measurement of current flow to a highest measurement of current flow.

Selecting the first data processing system may be facilitated by identifying the first data processing system that is ranked the lowest measurement of current flow (e.g., in a downward direction).

At operation 316, a determination may be made regarding operation of the rack has exceeded system limits. The determination may be made using at least the relative placements.

If it is determined that the operation of the rack has exceeded system limits (e.g., if the determination is “YES” at operation 318), then the method may proceed to operation 320.

At operation 320, a remediation plan may be obtained. The remediation plan may be obtained by using at least the relative placements. Obtaining the remediation plan may include: (i) identifying a data processing system in the rack that has exceeded the system limits, (ii) identifying a relative placement of a power shelf to the identified data processing system, (iii) generate an alternative placement for the power shelf to adjust the power supplied to the data processing system, and/or (iv) any other methods.

At operation 322, the remediation plan may be performed to update operation of the rack to prevent future operation of the rack from exceeding the system limits. The remediation plan may be performed by reading the instructions specified by the remediation plan and performing action sets according to the instructions. For example, the remediation plan may specify to physically adjust the location of the power shelf to move it to a different position within the rack such that the system limits may not be exceeded.

Returning to operation 318, if it is determined that the operation of the rack has not exceeded system limits (e.g., if the determination is “NO” at operation 318), then the method may proceed to operation 324.

At operation 324, supply of power to the data processing systems via the bus bar may be continued. The power supplied to the data processing systems may be continued by maintaining the connection between the power source, the power shelf, and the respective data processing systems positioned within the rack.

Thus, using the method illustrated in FIGS. 3A-3B, embodiments disclosed herein may manage operation of a rack of data processing systems to increase the likelihood of providing the computer implemented services as expected and/or desired by a client.

Any of the processes and/or components illustrated in and/or discussed with regard to FIGS. 1-3B may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a rack, the method comprising:
obtaining current flow measurements of current along a length of a bus bar of the rack;
identifying, using at least the current flow measurements, relative placements of data processing systems that draw power from the bus bar and power shelfs that supply power to the bus bar along the bus bar;
making, using at least the relative placements, a determination regarding operation of the rack has exceeded system limits;
in a first instance of the determination in which the rack has exceeded the system limits:
obtaining, using at least the relative placements, a remediation plan; and
performing the remediation plan to update operation of the rack to prevent future operation of the rack from exceeding the system limits.

2. The method of claim 1, wherein identifying the relative placements comprises:
identifying, using the current flow measurements, a first data processing of the data processing systems as an end unit;
identifying, using the current flow measurements, a second data processing system of the data processing systems as a neighbor unit for the first data processing system; and
obtaining the relative placements based, at least, on the end unit and the neighbor unit.

3. The method of claim 2, wherein identifying the first data processing system comprises:
rank ordering the data processing systems using a portion of the current flow measurements; and
selecting the first data processing system based on the rank ordering.

4. The method of claim 3, wherein the portion of the current flow measurements are a filtered set of the current flow measurements based on a current flow direction with respect to the bus bar.

5. The method of claim 4, wherein the first data processing system is selected for being associated with a smallest current flow measurement of the filtered set of the current flow measurements.

6. The method of claim 2, wherein identifying the second data processing system comprises:
identifying a first rate of current flow toward the first data processing system along the bus bar;
identifying rates of current flow away from each other data processing system of the data processing systems; and
making a determination that a rate of current flow of the current flow rates for the second data processing system is a closest rate to the first rate.

7. The method of claim 1, wherein obtaining the current flow measurement comprises:
obtaining a magnetic flux density measurement at a first position along the bus bar; and
using the magnetic flux density measurement to identify a magnitude and a direction of current flow through the bus bar at the first position.

8. The method of claim 7, wherein the magnetic flux density measurement is obtained using a sensor of a bar clip of a data processing system of the data processing systems.

9. The method of claim 8, wherein the bar clip comprises a second sensor, the sensor and the second sensor being positioned to monitor a first current and a second current at different positions along the bus bar.

10. The method of claim 9, wherein the different positions are on opposite sides of the bar clip along the bus bar.

11. A non-transitory machine-readable medium having instructions stored therein, which when executed by a processor, cause the processor to perform operations for managing operation of a rack: the operations comprising:
obtaining current flow measurements of current along a length of a bus bar of the rack;
identifying, using at least the current flow measurements, relative placements of data processing systems that draw power from the bus bar and power shelfs that supply power to the bus bar along the bus bar;
making, using at least the relative placements, a determination regarding operation of the rack has exceeded system limits;
in a first instance of the determination in which the rack has exceeded the system limits:
obtaining, using at least the relative placements, a remediation plan; and
performing the remediation plan to update operation of the rack to prevent future operation of the rack from exceeding the system limits.

12. The non-transitory machine-read medium of claim 11, wherein identifying the relative placements comprises:
identifying, using the current flow measurements, a first data processing of the data processing systems as an end unit;
identifying, using the current flow measurements, a second data processing system of the data processing systems as a neighbor unit for the first data processing system; and
obtaining the relative placements based, at least, on the end unit and the neighbor unit.

13. The non-transitory machine-readable medium of claim 12, wherein identifying the first data processing system comprises:
rank ordering the data processing systems using a portion of the current flow measurements; and
selecting the first data processing system based on the rank ordering.

14. The non-transitory machine-readable medium of claim 13, the portion of the current flow measurements are a filtered set of the current flow measurements based on a current flow direction with respect to the bus bar.

15. The non-transitory machine-readable medium of claim 14, the first data processing system is selected for being associated with a smallest current flow measurement of the filtered set of the current flow measurements.

16. A data processing system, comprising:
a processor; and
a memory coupled to the processor to store instructions, which when executed by the processor, cause the processor to perform operations for managing operation of a rack, the operations comprising:
obtaining current flow measurements of current along a length of a bus bar of the rack;
identifying, using at least the current flow measurements, relative placements of data processing systems that draw power from the bus bar and power shelfs that supply power to the bus bar along the bus bar;
making, using at least the relative placements, a determination regarding operation of the rack has exceeded system limits;
in a first instance of the determination in which the rack has exceeded the system limits:
obtaining, using at least the relative placements, a remediation plan; and
performing the remediation plan to update operation of the rack to prevent future operation of the rack from exceeding the system limits.

17. The data processing system of claim 16, wherein identifying the relative placements comprises:
identifying, using the current flow measurements, a first data processing of the data processing systems as an end unit;
identifying, using the current flow measurements, a second data processing system of the data processing systems as a neighbor unit for the first data processing system; and
obtaining the relative placements based, at least, on the end unit and the neighbor unit.

18. The data processing system of claim 17, wherein identifying the first data processing system comprises:
rank ordering the data processing systems using a portion of the current flow measurements; and
selecting the first data processing system based on the rank ordering.

19. The data processing system of claim 18, wherein the portion of the current flow measurements are a filtered set of the current flow measurements based on a current flow direction with respect to the bus bar.

20. The data processing system of claim 19, the first data processing system is selected for being associated with a smallest current flow measurement of the filtered set of the current flow measurements.
